(19) United States
(12) Patent Application Publication
(10) Pub. No.: US 2006/0008781 A1
(43) Pub. Date: Jan. 12, 2006

(54) System and method for measuring reading skills

(75) Inventors: Brent Townshend, Menlo Park, CA (US); Jared Bernstein, Palo Alto, CA (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Ordinate Corporation, Menlo Park, CA (US)

(21) Appl. No.: 11/176,834

(22) Filed: Jul. 6, 2005

Related U.S. Application Data
(60) Provisional application No. 60/585,656, filed on Jul. 6, 2004.

(51) Int. Cl. G09B 17/00

(52) U.S. Cl. 434/178

(57) ABSTRACT

A system and method for measuring reading skills is described. An individual whose reading skills are to be evaluated reads aloud from a text. As the person reads aloud from the text, a speech signal is captured. The speech signal is analyzed to provide an estimate of what the individual said and to measure a timing of the words said. The estimate and timing is combined with parameters assigned to each word said to form a measure of the individual's reading skill. The measure of the individual's reading skill is substantially independent of the text.

### RELATED APPLICATIONS

The present patent application claims priority under 35 U.S.C. § 119(e) to U.S. Provisional Patent Application Ser. No. 60/585,656, which was filed Jul. 6, 2004. The full disclosure of U.S. Provisional Patent Application Ser. No. 60/585,656 is incorporated herein by reference.

### FIELD

The present invention relates generally to measuring reading skills, and more particularly, relates to using a standardized scale to provide a measure of an individual's reading skills that is independent of material being read by the individual.

### BACKGROUND

Interactive language proficiency testing systems using speech recognition are known. For example, U.S. Pat. No. 5,870,709, issued to Ordinate Corporation, describes such a system. In U.S. Pat. No. 5,870,709, the contents of which are incorporated herein by reference, an interactive computer-based system is shown in which spoken responses are elicited from a subject by prompting the subject. The prompts may be, for example, requests for information, a request to read or repeat a word, phrase, sentence, or larger linguistic unit, a request to complete, fill-in, or identify missing elements in graphic or verbal aggregates, or any similar presentation that conventionally serves as a prompt to speak. The system then extracts linguistic content, speaker state, speaker identity, vocal reaction time, rate of speech, fluency, pronunciation skill, native language, and other linguistic, indexical, or paralinguistic information from the incoming speech signal.

The subject's spoken responses may be received at the interactive computer-based system via telephone or other telecommunication or data information network, or directly through a transducer peripheral to the computer system. It is then desirable to evaluate the subject's spoken responses and draw inferences about the subject's abilities or states.

Although interactive language proficiency testing systems provide many important features, there continues to be room for new features and improvements. One area in which there is room for improvement relates to creating a standardized scale for measuring reading skills that is independent of the material read by the subject. By measuring reading skills in a manner such that the material being read does not impact the score, a more reliable reading skills measure may be obtained. Accordingly, it would be beneficial to have a way to measure reading skills that is independent of the material read by the subject.

### SUMMARY

A system and method for measuring reading skills is described. A user reads aloud from a source text. The source text includes units of text, such as letter strings, pseudo-words, words, phrases, sentences, paragraphs, and extended passages. For example, a letter string may form a sub-word string, such as <ght> in “caught” or “lighten” or a pseudo-word, such as “strale” or “kaffish.” Each unit has a set of parameters that characterize the unit. The set of parameters for each unit includes salient linguistic and orthographic features of the presentation context and item response difficulties for this context. Additionally, the set of parameters for each unit includes a duration model specific to the unit of text.

A speech signal is formed when the user is reading aloud. The speech signal is captured either directly or via a recording of the speech signal. The speech signal is analyzed. An estimate of what the individual said when reading aloud is calculated. Additionally, latency and accuracy for each unit of text read is extracted. The accuracy includes the accuracy in word recognition, decoding, and oral reading. A rate based on time for reading each unit of text read from the source text is also measured. By combining the estimate of the phonological form, the extracted latency and accuracy, the time, and the set of parameters for each unit of text read, a measure of the individual's reading skill can be calculated. This measure of the individual's reading skill is substantially independent of the source text.

In one example, the measure is based on word-level statistics treating each word as a single “item.” For each word the following information is extracted: whether the word was correctly read; the time taken to decode and read the word; the presence of false starts, hesitations, or other filler; overall articulation rate of the speaker; and inherent “difficulty” of the item.

It is also possible to combine the measure of the individual's reading skill with comprehension evidence, such as through the use of secondary questions, to ascertain whether the user comprehended the source text.

These as well as other aspects and advantages will become apparent to those of ordinary skill in the art by reading the following detailed description, with reference where appropriate to the accompanying drawings. Further, it is understood that this summary is merely an example and is not intended to limit the scope of the invention as claimed.

### BRIEF DESCRIPTION OF THE DRAWINGS

Presently preferred embodiments are described below in conjunction with the appended drawing figures, wherein like reference numerals refer to like elements in the various figures, and wherein:

FIG. 1 is a block diagram of a system for measuring reading skills, according to an example;

FIG. 2 is a flow diagram of a method for measuring reading skills, according to an example; and

FIG. 3 is a flow diagram of a method for measuring reading skills, according to another example.

### DETAILED DESCRIPTION

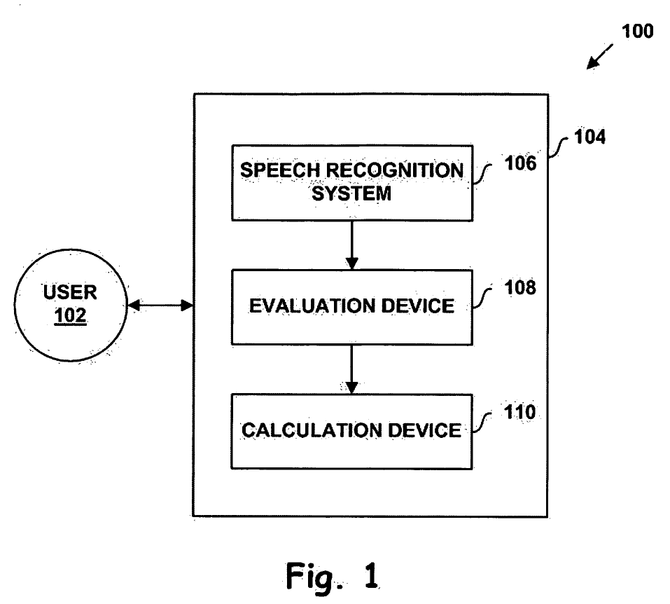

FIG. 1 is a block diagram of a system 100 for measuring reading skills. The system 100 interacts with a user 102 whose reading skills are to be measured and includes a computing platform 104. While FIG. 1 depicts a direct connection between the user 102 and the computing platform 104, there may be a network and/or other entities connecting the user 102 and the computing platform 104.

The user 102 may be, for example, a student (child or adult) in a formal education program, a job applicant seeking employment requiring a certain level of reading proficiency, or someone who is interested in knowing his or her reading skill level for any reason. For example, the user 102 may be learning how to read and measuring improvement in reading skill may provide useful information regarding the user's progress.

The user 102 reads aloud from a source text. The source text may be any combination of units. The units may be letter strings, pseudo-words, words, phrases, sentences, paragraphs, extended passages, and so on. Preferably, the units are words. The user 102 may read aloud from the source text in a manner such that the computing platform 104 can detect speech signals as the user 102 reads aloud. Alternatively, the speech signals may be recorded as the user 102 reads aloud, and a recording of the user's responses may be presented to the computing platform 104. The computing platform 104 may capture the speech signals.

The computing platform 104 may be any combination of hardware, software, and/or firmware. The computing platform 104 is shown as a simple rectangular box in FIG. 1 to emphasize the variety of different forms the computing platform 104 may take on from one example to the next. In the illustrated form, the computing platform 104 includes a speech recognition system 106, an evaluation device 108, and a calculation device 110. While the speech recognition system 106, the evaluation device 108, and the calculation device 110 are shown as separate entities in FIG. 1, two or more of the speech recognition system 106, the evaluation device 108, and the calculation device 110 may be combined into a single entity.

The computing platform 104 may include additional entities as well, such as an input device, an output device, and memory. Input devices may include a mouse, a keyboard, and a microphone. Output devices may include a display, a speaker, and a printer. The memory may include volatile and/or non-volatile memory devices. Additionally, the memory may be located on a memory chip on a printed circuit board or located on a magnetic or optical drive disk.

The speech recognition system 106 may be any combination of hardware, software, and/or firmware. Preferably, the speech recognition system 106 is implemented in software. For example, the speech recognition system 106 may be the HTK software product, which is owned by Microsoft and is currently available for free download from the Cambridge University Engineering Department's web page (http://htk.eng.cam.ac.uk). The speech recognition system 106 may receive signals representing the speech of the user 102 who is reading the source text aloud.

The speech recognition system 106 may be an automatic speech recognition system that operates by recognizing and aligning responses to provide an estimate of the speech. The calculated estimate may be an estimate of linguistic content of the speech and may be in the form of a data stream that represents the user's speech. The linguistic content of speech may include a distinctive feature, a segment, a phoneme, a syllable, a morpheme, a word, a syntactic phrase, a phonological phrase, a sentence, a paragraph, and an extended passage. For example, the output of the speech recognition system 106 may be a sequence of words in a machine recognizable format, such as American Standard Code for Information Interchange (ASCII).

The evaluation device 108 may be any combination of hardware, software, and/or firmware. Preferably, the evaluation device 108 is implemented in software. The evaluation device 108 may extract latency and accuracy for each unit of text read by the user. The evaluation device 108 measures a time for each unit of text read. The time may be measured between an end of one unit of text read and an end of another unit of text read. The measured time may be scaled to account for variations in the user's articulation rate. The scaling of the measured time may be performed using a duration model, which is a model of expected duration of a linguistic form of a unit of text. The linguistic form may include phonological structure, morphological structure, lexical structure, stochastic structure, and/or syntactic structure of the text units.

The duration model may be generated by analyzing a sample of representative users that are known “good” readers and measuring statistics of durations. The measured statistics may be used to create a model (i.e., the duration model) that predicts how deviant a given duration is. A deviant duration is typically longer than the model durations. The duration model, a text model, and each individual observation may be used to create an estimate of the reader's ability.

The calculation device 110 may be any combination of hardware, software, and/or firmware. Preferably, the calculation device 110 is implemented in software. The calculation device 110 combines the estimate of what the user said when reading the source text, the measurement of time for each unit of text read, and a set of parameters assigned to each unit of text read. This combination may be used to form a measure of the user's reading skill.

The set of parameters for each unit of text in the source text may be included in the calculation device 110. Alternatively, the set of parameters may be provided to the calculation device 110 by another device located within the computing platform 104 or remotely. The set of parameters for each unit of text may be calculated using statistical analysis, such as Item Response Theory, to evaluate the units of text. Details on Item Response Theory may be found in “Introduction to Classical and Modern Test Theory,” authored by Linda Crocker and James Algina, Harcourt Brace Jovanovich College Publishers (1986), Chapter 15; and “Best Test Design; Rasch Measurement,” by Benjamin D. Wright and Mark H. Stone, Mesa Press, Chicago, Ill. (1979), the contents of both of which are incorporated herein by reference.

The set of parameters for each unit includes salient linguistic and orthographic features of the presentation context and item response difficulties for this context. Additionally, the set of parameters may include a duration model for each unit of text. The set of parameters may be based on an analysis of speech formed by a plurality of individuals reading each unit of text in a similar context. The similar context relates to the linguistic structure of any superordinate linguistic unit and/or to the probability of the unit occurring within a word sequence that includes the unit. Alternatively, the set of parameters may be based on an analysis of speech formed by a plurality of individuals reading each unit of text in various contexts. In this example, the analysis may include identifying similarities within the speech.

The plurality of individuals may have a known set of characteristics, such as demographic characteristics and skill-level characteristics. The demographic characteristics may include age, gender, race, ethnicity, as well as other characteristics. The skill-level characteristics may include spoken language proficiency, reading comprehension skill, educational achievement, vocabulary skill, as well as other characteristics.

The set of parameters for each unit may also include any superordinate linguistic unit within which the unit occurs. Thus, for example, a parameter of a word can be a structural schema relating to the noun phrase within which the unit occurs. This example may enable the parametric model to more accurately estimate reading skill for a word item by using schematic context to adjust the expected elapsed time for the word.

Where any or all of the speech recognition system 106, the evaluation device 108, and the calculation device 110 are implemented in software, the computing platform 104 will typically be associated with a general purpose or application specific processor and memory. In addition, the computing platform 104 may be coupled to or include one or more input and/or output devices, such as a keyboard, microphone, speaker, display, etc. For a computing platform 104 that includes or is coupled to a display, the display may present the source text to the user 102. Alternatively, the user 102 may read aloud from a source text that is independent from the computing platform 104, such as a book or pamphlet, although in such cases the source text needs to be identified to the computing platform 104.

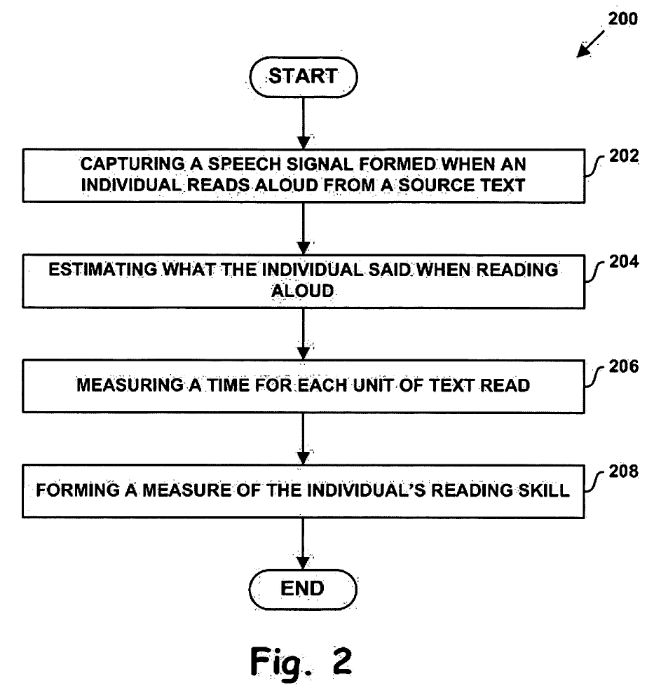

FIG. 2 is a flow diagram of a method 200 for measuring reading skills. At block 202, a speech signal is captured. The speech signal may be captured when the speech signal is formed as the user 102 reads aloud from a source text. The speech signal may be captured directly by the speech recognition system 106 or may be recorded first and then provided to the speech recognition system 106.

The source text may be formed by units. The units may be a subset of the text, such as letter strings, words, phrases, sentences, paragraphs, and extended passages. The source text may be designed to have a difficulty level. The difficulty level of the source text may remain the same or vary throughout the text. For example, the difficulty level of the source text may increase as the user 102 reads aloud from the source text.

At block 204, an estimate of speech is calculated. The speech recognition system 106 may calculate an estimate of the speech. The calculated estimate may be an estimate of the linguistic content of the speech and may be in the form of a data stream that represents the user's speech. For example, the output of the speech recognition system 106 may be a sequence of words in a machine recognizable format, such as ASCII.

At block 206, a time for each unit of text read is measured. The evaluation device 108 may measure the elapsed time for each unit of text read. The time may be measured between an end of one unit of text read and an end of another unit of text read. The measured time may be scaled to account for variations in the user's articulation rate.

At block 208, a measure of the individual's reading skill is formed. The measure of the individual's reading skill may be substantially independent of the source text. The measure of the user's reading skill may be formed by combining the estimate of the speech, the measurement of time for each unit of text read, and a set of parameters for each unit of text read. The set of parameters for each unit includes salient linguistic and orthographic features of the presentation context and item response difficulties for this context. Additionally, the set of parameters may include a duration model for each unit of text and any superordinate linguistic unit within which the unit occurs.

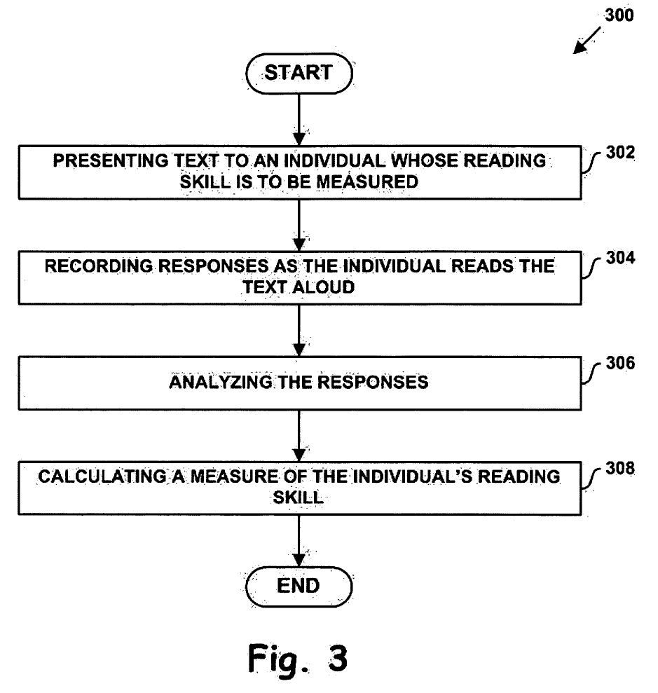

FIG. 3 is a flow diagram of a method 300 for measuring reading skills according to another example. At block 302, text is presented to an individual. The individual is the user 102 whose reading skill is to be measured. The text may be presented to the individual in a written format, such as text on a piece of paper, or in an electronic format, such as on a computer monitor. The text may be comprised of words, and have a constant or varying difficulty level.

At block 304, the individual reads the text and the individual's responses are recorded. The individual's responses may be recorded by any recording device, such as a tape recorder. The recording device may be integrated into the computing platform 104 or may be a stand-alone device. If the recording device is a stand-alone device, the responses may be presented to the computing platform 104, which may be detected by the speech recognition system 106.

At block 306, the responses are analyzed. The response may be analyzed by an automatic speech recognition system, such as the speech recognition system 106. The responses may be analyzed based on a set of parameters defined for each word in the text, timing of the response, accuracy of the response, and characteristics of the individual.

The set of parameters for each unit includes salient linguistic and orthographic features of the presentation context and item response difficulties for this context. Additionally, the set of parameters may include a duration model for each unit of text. The timing of the response may be calculated by measuring the time between the end of one word and the end of another word read. The accuracy of the response may be determined by the speech recognition system 106.

The characteristics of the individual may include demographic characteristics and skill-level characteristics. The demographic characteristics may include age, gender, race, ethnicity, as well as other characteristics. The skill-level characteristics may include spoken language proficiency, reading comprehension skill, educational achievement, vocabulary skill, as well as other characteristics.

At block 308, a measure of the individual's reading skill is calculated. The measure of the individual's reading skill may be substantially independent of the text. The measure of the user's reading skill may be based on the analysis of the set of parameters defined for each word in the text, the timing of the response, the accuracy of the response, and the characteristics of the individual.

By measuring reading skills in the described manner, an estimate of an individual's reading skill can be estimated such that the estimate is independent of the source text. So if an individual's reading skill is evaluated multiple times in a short time frame using different source texts, the individual may receive a substantially similar reading skill measurement for each of the source texts read. Accordingly, a reading skill scale can be formed that is substantially independent of the material read.

Further, the reading skill measurement may be calculated by analyzing an individual's response when reading aloud for a short period of time. As a result, a reliable reading skill measurement may be obtained with minimal inconvenience to the individual.

It is also possible to combine the measure of the individual's reading skill with comprehension evidence to ascertain whether the user comprehended the source text. Secondary questions may be used to determine a user's level of comprehension. For example, the individual may be asked a series of questions regarding the content of the source text. Based on the user's responses to the questions, a user's comprehension may be ascertained.

It should be understood that the illustrated embodiments are examples only and should not be taken as limiting the scope of the present invention. The claims should not be read as limited to the described order or elements unless stated to that effect. Therefore, all embodiments that come within the scope and spirit of the following claims and equivalents thereto are claimed as the invention.

We claim:

1. A method for measuring reading skills of a plurality of individuals on a single scale, comprising in combination:
capturing a speech signal formed when an individual reads aloud from a source text;
estimating linguistic content of what the individual said when reading aloud;
extracting latency and accuracy for units of text read from the source text;
measuring elapsed time for the units of text read from the source text;
combining the estimated linguistic content, the extracted latency and accuracy, the elapsed time, and a set of parameters for the units of text read from the source text to form a measure of the individual's reading skill that is substantially independent of the source text.

2. The method of claim 1, wherein the linguistic content is selected from the group consisting of a distinctive feature, a segment, a phoneme, a syllable, a morpheme, a word, a syntactic phrase, a phonological phrase, a sentence, a paragraph, and an extended passage.

3. The method of claim 1, wherein a unit of text is selected from the group consisting of a letter string, a word, a phrase, a sentence, a paragraph, and an extended passage.

4. The method of claim 1, wherein the elapsed time is measured between an end of one unit of text read and an end of another unit of text read.

5. The method of claim 1, wherein the elapsed time for the units of text read is scaled to account for variations in the individual's articulation rate.

6. The method of claim 1, wherein the elapsed time for the units of text read is scaled according to a duration model that depends on a linguistic form of the units of text read, wherein the linguistic form of the units of text read includes structure selected from the group consisting of phonological, morphological, lexical, stochastic, and syntactic.

7. The method of claim 1, wherein the set of parameters for the units of text read includes at least one of an item response theory difficulty, a duration model for the units of text read, and any superordinate linguistic unit in which the units of text read occur.

8. The method of claim 1, wherein the set of parameters for the units of text read is based on analysis of speech produced by a plurality of individuals having known characteristics selected from the group consisting of demographic characteristics and skill-level characteristics.

9. The method of claim 8, wherein the plurality of individuals read the units of text in a similar context including at least one of a linguistic structure of any superordinate linguistic unit and probability of the text occurring within a word sequence that includes the text.

10. A method for measuring reading skills, comprising in combination:
presenting text to a individual whose reading skill is to be measured;
recording responses as the individual reads the text aloud;
analyzing the responses based on a set of parameters defined for words in the text, timing of the response, and accuracy of the response; and
calculating a measure of the individual's reading skill based on the analysis, wherein the measure of the individual's reading skill is substantially independent of the text.

11. The method of claim 10, wherein analyzing the responses includes an automatic speech recognition system performing the analysis.

12. The method of claim 10, wherein the set of parameters defined for the words in the text is based on analysis of speech formed by a plurality of individuals reading the words in the text in a similar context, wherein the similar context includes at least one of a linguistic structure of any superordinate linguistic unit and probability of the text occurring within a word sequence that includes the text.

13. The method of claim 10, wherein the set of parameters defined for the words in the text include at least one of an item response theory difficulty, a duration model, and any superordinate linguistic unit within which the word occurs.

14. The method of claim 10, further including analyzing the responses based on characteristics of the individual, wherein the characteristics of the individual are selected from the group of characteristics consisting of demographic characteristics and skill-level characteristics.

15. A system for measuring reading skills, comprising in combination:
a processor;
data storage; and
machine language instructions stored in the data storage executable by the processor to:
capture a speech signal formed when an individual reads aloud from a source text;
estimate linguistic content of what the individual said when reading aloud;
extract latency and accuracy for units of text read from the source text;
measure elapsed time for the units of text read from the source text; and
combine the estimate of linguistic content, the extracted latency and accuracy, the elapsed time, and a set of parameters for the units of text read from the source text to form a measure of the individual's reading skill that is substantially independent of the source text.

16. The system of claim 15, wherein the linguistic content is selected from the group consisting of a distinctive feature, a segment, a phoneme, a syllable, a morpheme, a word, a syntactic phrase, a phonological phrase, a sentence, a paragraph, and an extended passage.

17. The system of claim 15, wherein the units of text are selected from the group consisting of a letter string, a word, a phrase, a sentence, a paragraph, and an extended passage.

18. The system of claim 15, wherein the elapsed time is measured between an end of one unit of text read and an end of another unit of text read.

19. The system of claim 15, wherein the elapsed time for the units of text read is scaled to account for variations in the individual's articulation rate.

20. The system of claim 15, wherein the elapsed time for the units of text read is scaled according to a duration model that depends on a linguistic form of the units of text read, wherein the linguistic form of the units of text read includes structure selected from the group consisting of phonological, morphological, lexical, stochastic, and syntactic.

21. The system of claim 15, wherein the set of parameters includes at least one of an item response theory difficulty, a duration model for the units of text read, and any superordinate linguistic unit in which the units of text read occurs.

22. The system of claim 15, wherein the set of parameters for the units of text read is based on analysis of speech produced by a plurality of individuals reading the units of text in a similar context, wherein each of the plurality of individuals reading the source text has known characteristics selected from the group consisting of demographic characteristics and skill-level characteristics.

23. The system of claim 15, wherein the similar context includes at least one of a linguistic structure of any superordinate linguistic unit and probability of the text occurring within a word sequence that includes the text.
